(19) United States
(12) Patent Application Publication
(10) Pub. No.: US 2009/0218332 A1
(43) Pub. Date: Sep. 3, 2009

(54) BOILERLESS COMBINATION CONVECTION STEAMER OVEN

(75) Inventors: Dipak J. Negandhi, Brandon, MS (US); Terry A. Owens, Florence, MS (US); Bill Hemsath, Madison, MS (US); George R. Gauthier, Bethlehem, PA (US)

Correspondence Address: BUTLER, SNOW, O'MARA, STEVENS & CANNADA PLLC, 6075 POPLAR AVENUE, SUITE 500, MEMPHIS, TN, 38119, US

(73) Assignee: UNIFIED BRANDS, INC., Jackson, MS (US)

(21) Appl. No.: 12/350,794

(22) Filed: Jan. 8, 2009

Related U.S. Application Data
(60) Provisional application No. 61/019,909, filed on Jan. 9, 2008.

(51) Int. Cl. F24C 7/06; F24C 15/00; A47J 27/04; F24C 13/00

(52) U.S. Cl. 219/393; 219/395; 219/398; 219/401; 219/402; 219/412

(57) ABSTRACT

A boilerless combination convection steamer oven and controls logic therefor is provided having a cooking cavity formed of a steam generating space with two or more reservoirs and a cooking space, wherein the steam generating space is separated from the cooking space by a removable steam lid, any number from none to all of the reservoirs may be filled depending on the selected cooking mode, and each reservoir of the steam generating space is heated by a separate heating element.

### RELATED APPLICATIONS

NOT APPLICABLE

### STATEMENT REGARDING FEDERALLY SPONSORED RESEARCH OR DEVELOPMENT

NOT APPLICABLE

### REFERENCE TO A “MICROFICHE APPENDIX”

NOT APPLICABLE

### FIELD OF THE INVENTION

This invention relates to a boilerless combination convection steamer oven wherein a steam generator is integral to the cooking cavity, multiple reservoirs may be filled or emptied to achieve the desired combination of heating and steam, and separate heating elements may be turned on or off as per the selected cooking mode and controls logic.

### BACKGROUND OF THE INVENTION

The steamer or combination oven incorporating a steamer is a vital part of many commercial and institutional kitchens. Since its introduction, the bulk steamer has been the only steamer appliance capable of producing adequate steam for rapid and large volume food production. Most of these bulk steamers and most combination ovens incorporating a steamer feature a cavity for cooking food products and a separate steam generator for steam production connected via steam transmission tube. The problem with this design of a steam generation system is the formation of lime scale inside the steam generator. Many cleaning methods and different generator designs have been developed over the years; however nothing has been developed to effectively and efficiently eradicate the lime scale build up. Because bulk steamers and combination ovens incorporating steamers with the steam generator separate from the cavity cannot be thoroughly cleaned by the user of the equipment, these bulk steamers require service calls and unnecessary down time to professionally clean the steam generator or replace it.

Connectionless steamers can be made with a steam generator which is integral to the cooking cavity. However, the majority of these connectionless steamers do not create the same amount of steam as a bulk steamer. In most connectionless steamers, the condensate forms and is then reintroduced to the boiling reservoir. A connectionless steamer does not have a condensate drain or a water trapping lid. For the end user that needs the power of the bulk steamer, the connectionless steamer is not an option, but the need for an easy to clean generator is still there. The bulk steamer problem was largely solved by the Unified Brands boilerless steamer apparatus, patented at U.S. Pat. No. 7,025,104, but that invention is solely a steamer as disclosed. It is beneficial both for space-saving reasons and for optimal cooking reasons to have an oven that can act as both a steamer and a convection oven or that can cook with a combination of heat and steam and that does not have the problems associated with a separate boiler.

Presently, most combination ovens require two heat sources, one to heat the oven and another to heat the water to provide steam. Also, most combination ovens either require a separate boiler to generate steam or generate steam via the method of spraying water into a heated oven via a fan where water is applied directly to a heating element, typically causing a quenching effect. Thus, the presently available combination ovens have many of the same cleaning problems as most bulk steamers, other than the Unified Brands boilerless steamer listed above. The present invention solves those problems.

### SUMMARY OF THE INVENTION

Unlike the traditional bulk steamers and combination ovens incorporating that technology, the present boilerless combination convection steamer oven has a steam generator which is integral to the cooking cavity thus making the steam generator easily accessible for operator cleaning. In its steam mode, the present boilerless combination convection steamer oven features the cooking power of a bulk steamer with the cleaning benefits of a connectionless steamer.

The present invention provides a boilerless combination convection steamer oven with multiple modes which may include a steam cooking mode, a heat-only dry oven cooking mode, and high and low humidity combination heat and steam cooking modes. The oven has a cooking cavity formed by a cooking cavity wall consisting essentially of a steam generating space separated from a cooking space by a removable steam lid. The steam generating space is divided into multiple reservoirs. Anywhere from none to all of the reservoirs may be filled depending on the cooking mode selected. In a preferred embodiment, there is a separate heating element, which may be gas, electric, or any other type of heating element, which is disposed adjacent to and preferably below each of the reservoirs which can act both to provide steam if the reservoir is filled and to heat the cooking cavity. The removable steam lid is spaced apart from the steam cavity wall to form a pressure differential between the cooking space and the steam generating space. The removable steam lid is formed to remove condensate from the cooking space. In a preferred embodiment, the byproducts of the heating elements, which can include flue gasses and heated air, are vented via a space around and above the cooking cavity such that they provide additional heat to the cooking cavity and minimize condensation of steam vapors on the sides and top of the cooking cavity. In a preferred embodiment, heat dispersion plates may be placed between the heating elements and the reservoirs.

The present invention provides for easy cleaning of the combination boilerless combination convection steamer oven by removing the removable steam lid for cleaning and replacing the removable steam lid into the apparatus upon completion. In a preferred embodiment, it also provides for a cleaning cycle in which a user sprays cleaning solution into the oven, and the oven completes a cleaning cycle. Although not shown in the diagrams herein, the cleaning cycle could also be completely automated by integrating the spraying of cleaner into the oven and then the occurring of the disclosed cleaning cycle. The removable steam lid may be cleaned in place in the apparatus or as removed if the user so chooses, to clean the steam lid in, for example, a commercial dish washer.

The present invention provides also for a controls logic. According to the controls logic, a user selects a cooking mode. The oven will warm up to 200 degrees Fahrenheit as disclosed in the logic and then fill the appropriate number of reservoirs based on the chosen cooking mode. The heating elements activate to provide the appropriate amount of heat and steam depending on the cooking mode chosen by the user. A cleaning mode is also provided allowing for soaking, automatic rinsing, and draining of the cooking cavity.

In view of the above, it is an object of the present invention to provide a boilerless combination convection steamer oven which is easily cleaned, so no separate boiler is required.

Another object of the present invention is to provide a boilerless combination convection steamer oven for which one set of heating elements can provide both heat to the oven and heat to create steam.

### BRIEF DESCRIPTION OF THE DRAWINGS

FIG. 1 is a front view of the boilerless combination convection steamer oven.

FIG. 2 is a right side view of the boilerless combination convection steamer oven with the outer panel removed.

FIG. 3 is a left side view of the boilerless combination convection steamer oven with the outer panel removed.

FIG. 4 is a back view of the boilerless combination convection steamer oven.

FIG. 5 is a front view of the boilerless combination convection steamer oven with the door removed.

FIG. 6 is a back view of the boilerless combination convection steamer oven with the rear panel removed.

FIG. 7 is a cross-sectional view from the center of the boilerless combination convection steamer oven towards the right interior wall.

FIG. 8 is a cross-sectional view from the center of the boilerless combination convection steamer oven towards the left interior wall.

FIG. 9 is a cross-sectional view from the center of the boilerless combination convection steamer oven towards the rear wall.

FIG. 10 is a cross-sectional view from the center of the boilerless combination convection steamer oven towards the front.

FIG. 11 is a cross-sectional view from the center of the boilerless combination convection steamer oven towards the bottom with the steam lid in place.

FIG. 12 is a cross-sectional view from the center of the boilerless combination convection steamer oven with the steam lid removed.

FIG. 13A is a cross-sectional view of optional reservoir shapes.

FIG. 13B is a cross-sectional view of an optional reservoir shape showing the placement of heat dispersion plates and heating elements relative to the reservoirs.

FIG. 13C is an isometric view from below of an optional reservoir configuration showing heat dispersion plates.

FIG. 13D is an isometric view from above of an optional reservoir configuration.

FIG. 14 is a top view of the burner assembly.

FIG. 15 is a view of the controls.

FIG. 16A shows views of the front and back of the back baffle.

FIG. 16B is an isometric view of the back baffle when viewed from the front of the oven.

FIG. 17 is an isometric view of the bottom baffle.

FIG. 18A is a rear view of the boilerless combination convection steamer oven with outer panel and back baffle removed with arrows showing the flow of steam.

FIG. 18B is a right side view of the boilerless combination convection steamer oven with outer panel removed with arrows showing the flow of steam.

FIG. 19A is a right side view of the boilerless combination convection steamer oven with outer panel removed with arrows showing the flow of heating byproducts.

FIG. 19B is a rear view of the boilerless combination convection steamer oven with outer panel and back baffle removed with arrows showing the flow of heating byproducts.

FIG. 20 is a controls logic for the controls operating the boilerless combination convection steamer oven.

### DETAILED DESCRIPTION OF THE INVENTION

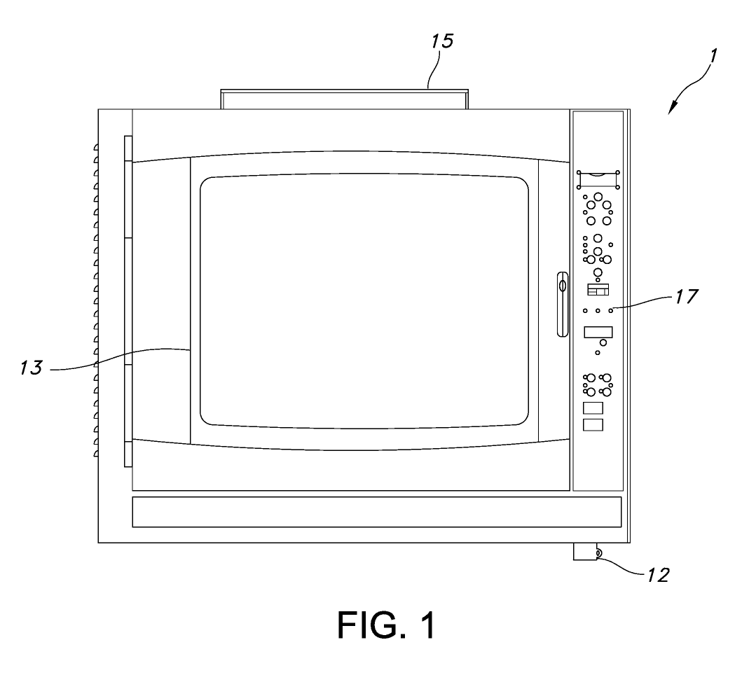

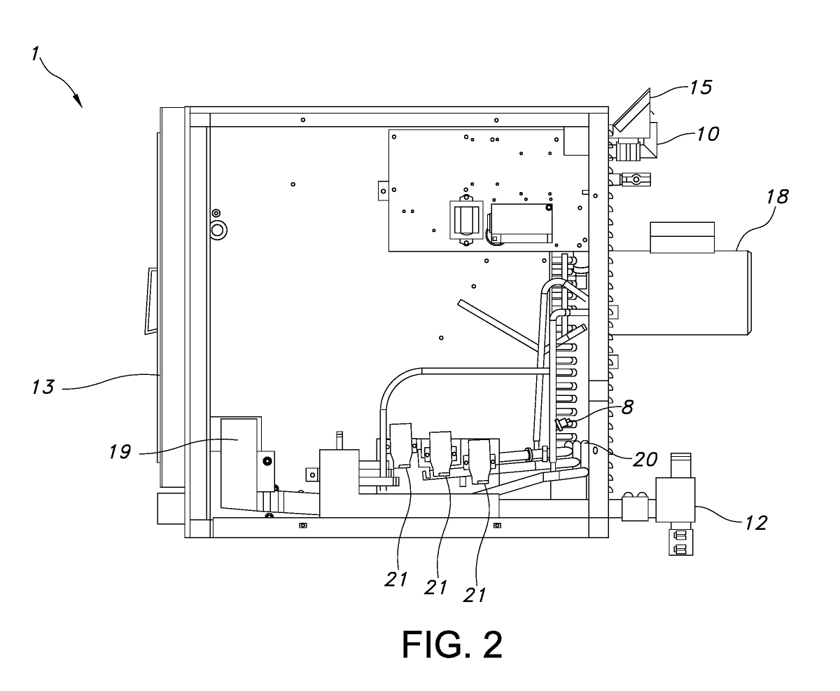

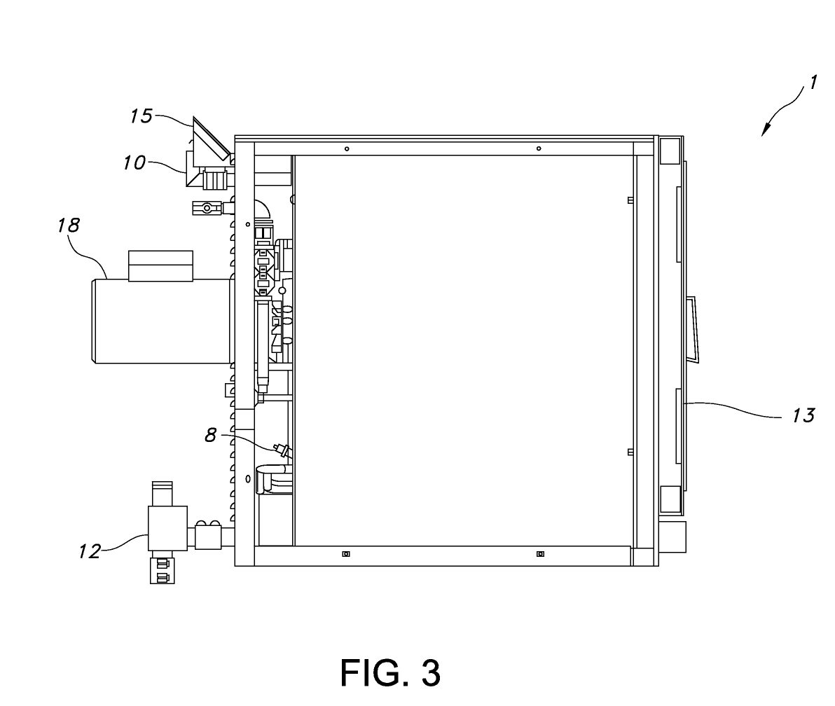

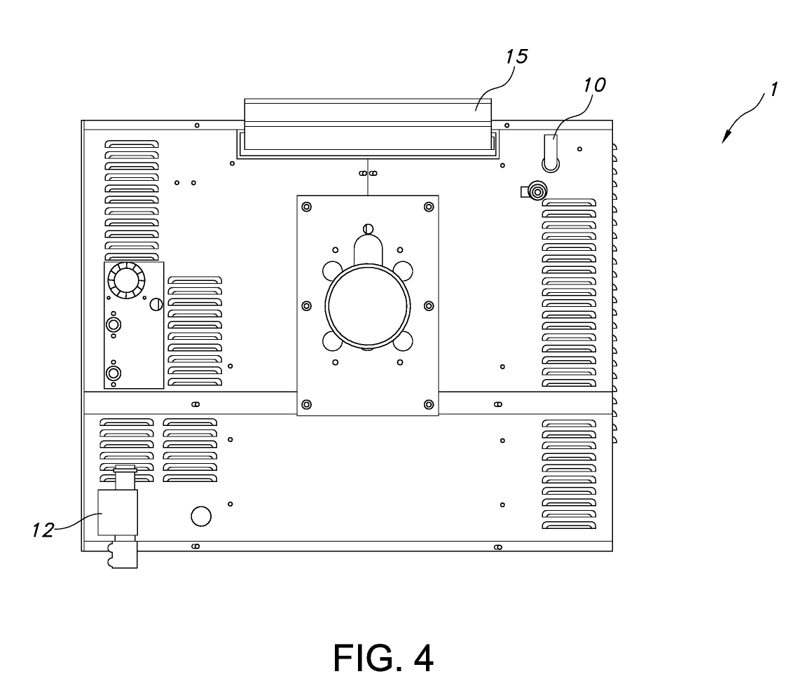

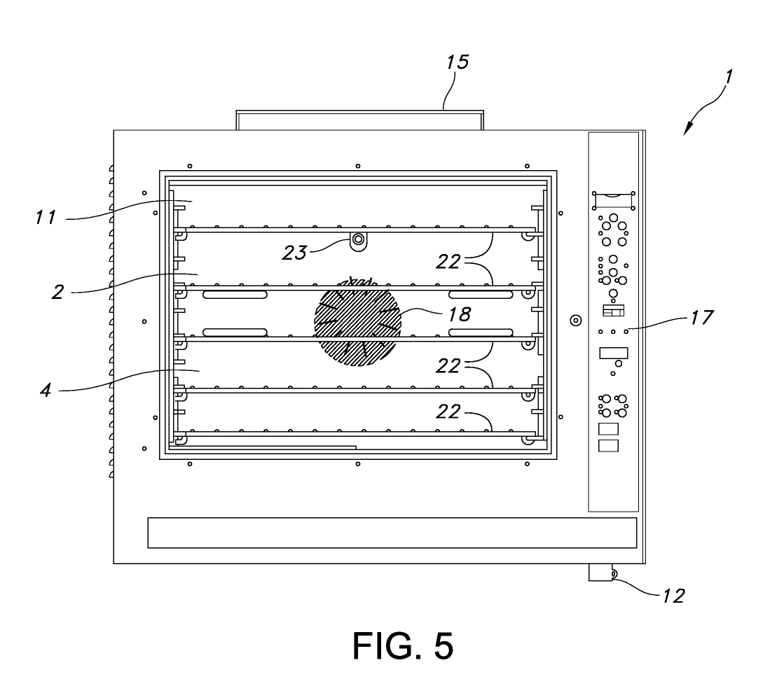

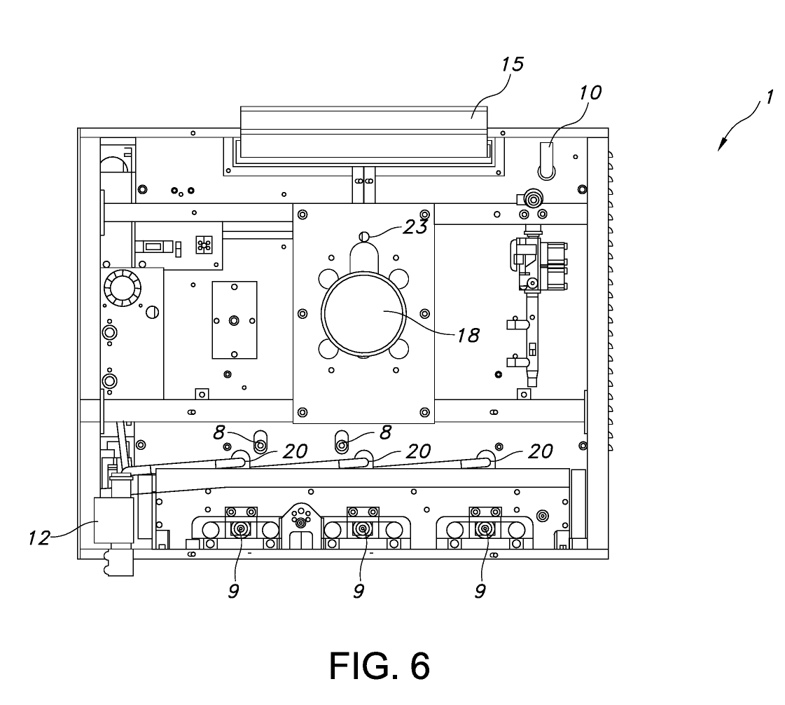

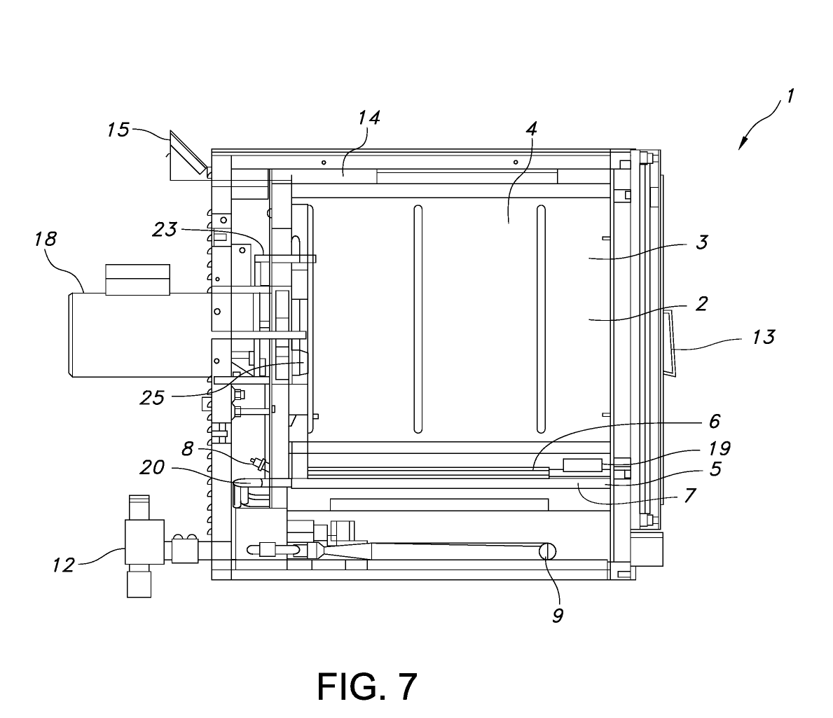

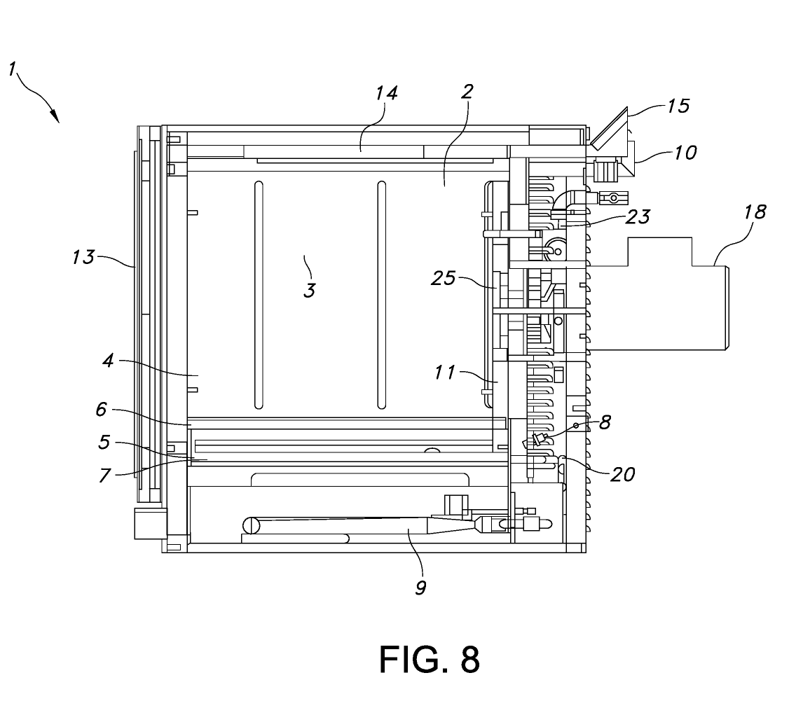

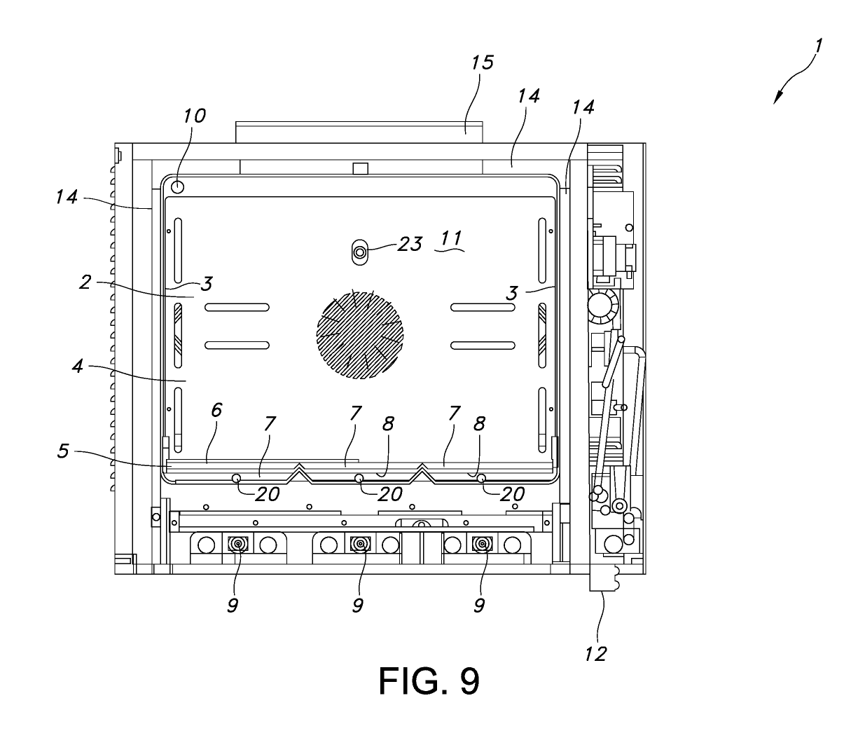

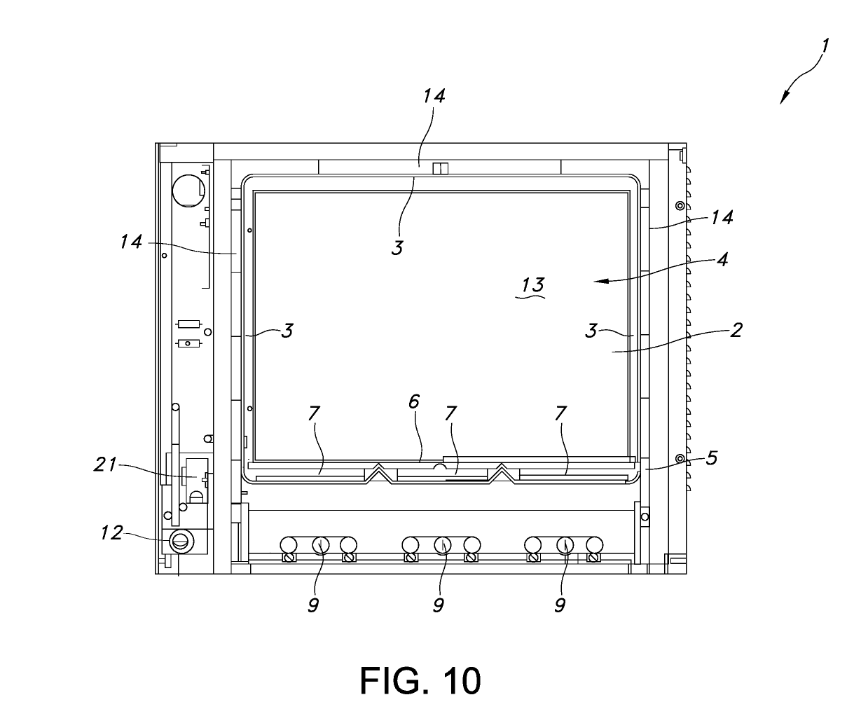

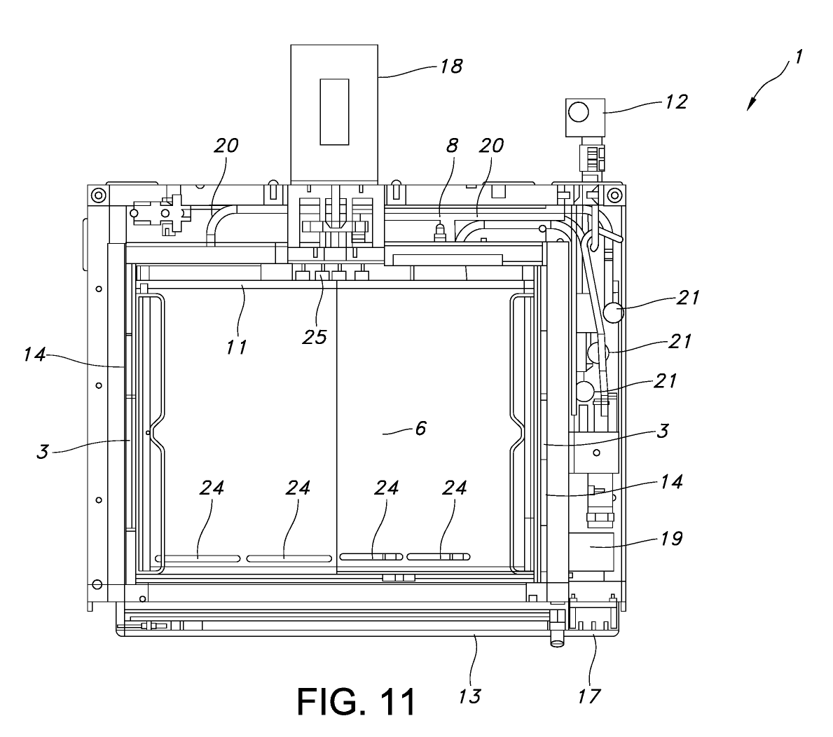

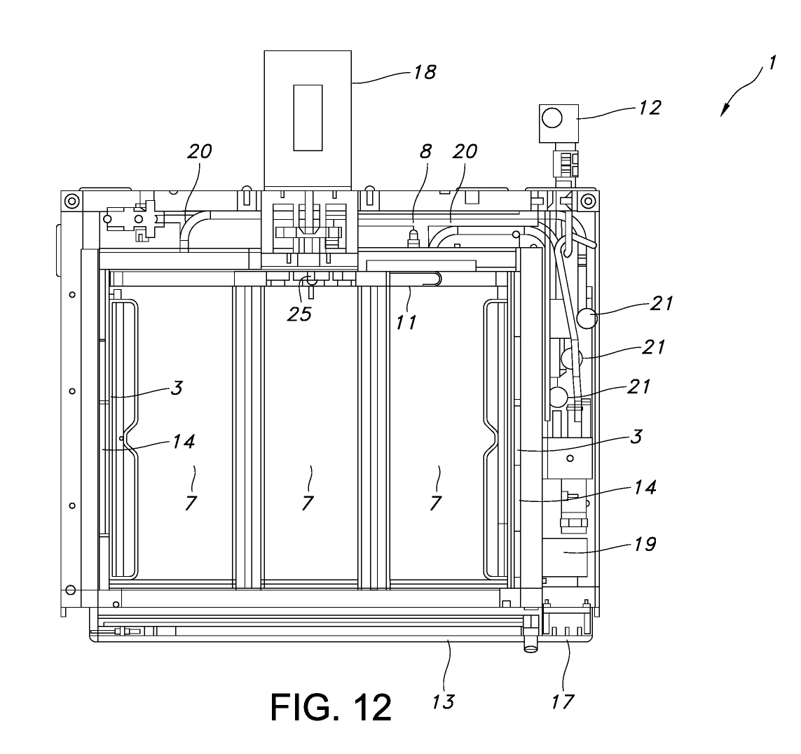

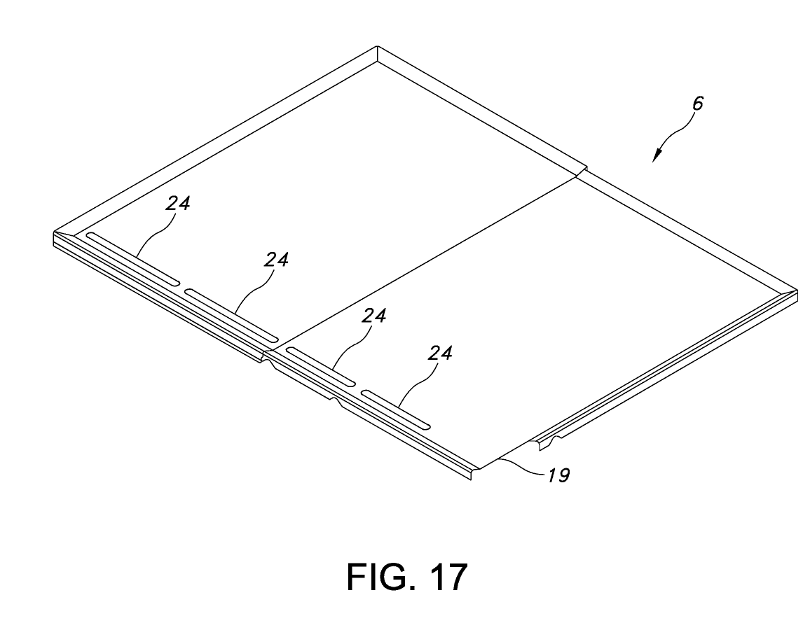

With reference to the drawings, and particularly with regards to FIG. 1 through FIG. 12, these figures show the boilerless combination convection steamer oven 1 of the present invention from various angles and cross-sections. The boilerless combination convection steamer oven 1 has a cooking cavity 2 formed by a cooking cavity wall 3. The cooking cavity 2 is separated into a cooking space 4 and a steam-generating space 5 which are separated from each other by a removable steam lid 6. Food is cooked on racks 22 within the cooking space 4. The removable steam lid 6 is shown in more detail in FIG. 17 which shows it can be made in two separable parts. The removable steam lid 6 has steam lid slots 24 through which steam or heated air may flow. The removable steam lid 6 also slants towards a steam lid drain 19 through which the majority of the byproducts of cooking, primarily any drippings or spills from any cooking food and any condensate, which gather on the steam lid 6 drain out of the boilerless combination convection steamer oven 1. The steam lid 6 is shown in FIG. 17 for easier viewing of the steam lid slots 24 and the placement of the steam lid drain 19. Fluids that gather on the steam lid 6 which reach the steam lid drain 19 exit the oven 1 via the oven drain 12.

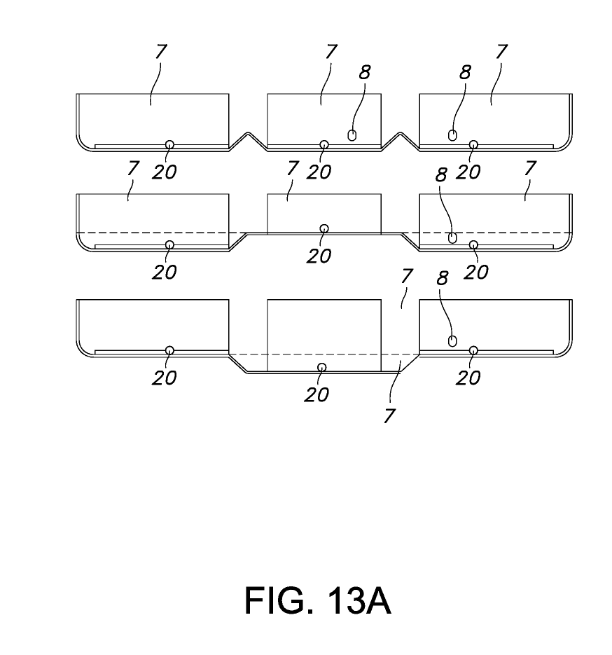

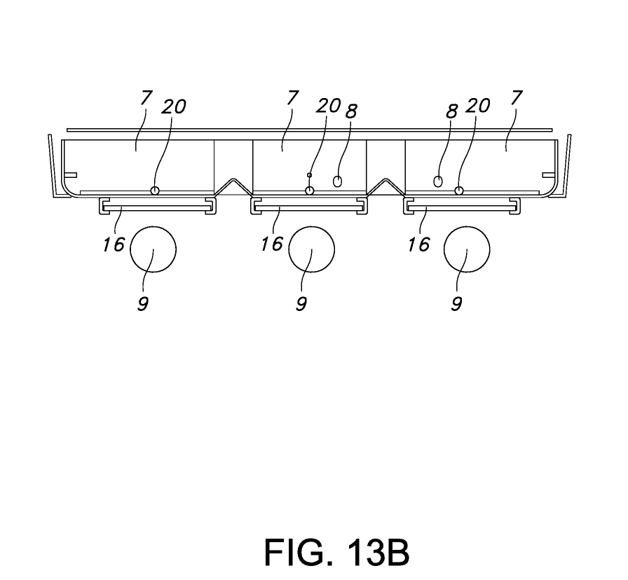

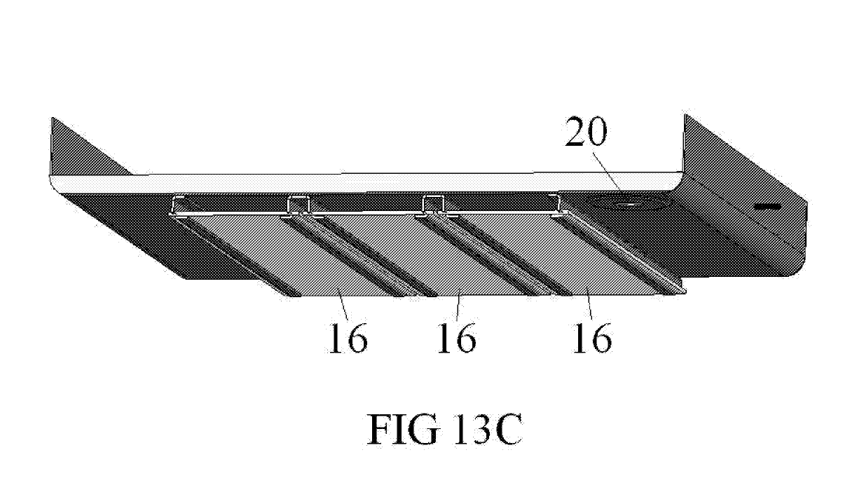

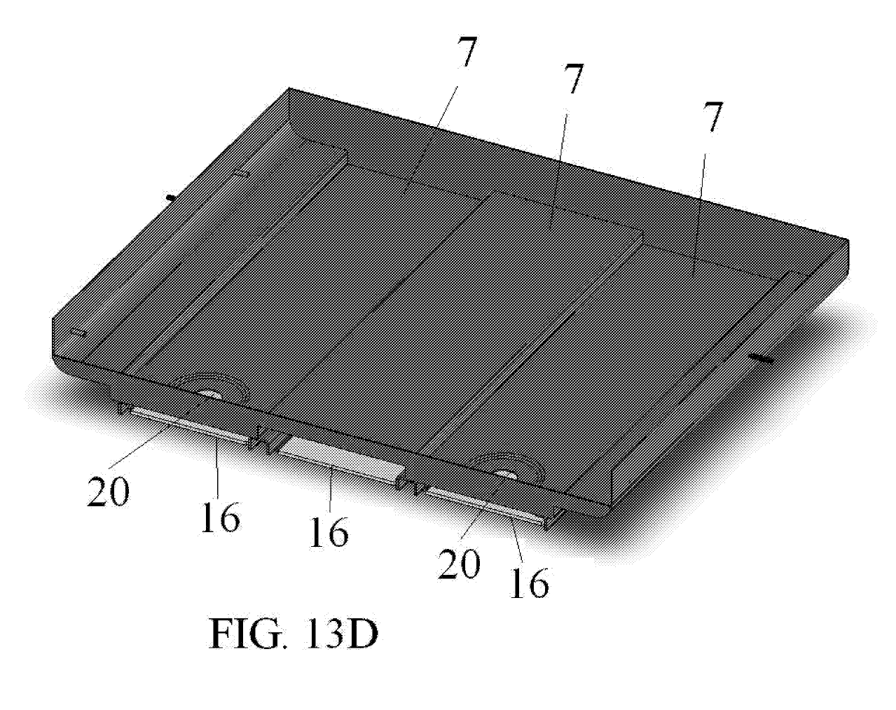

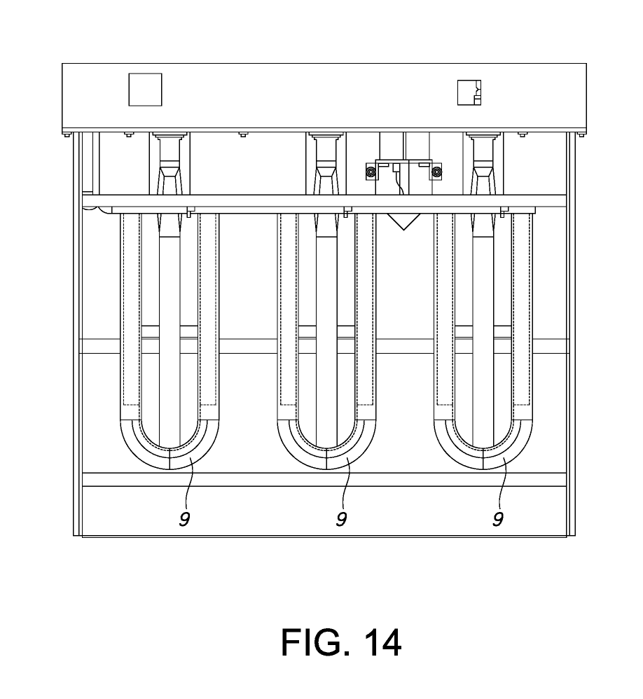

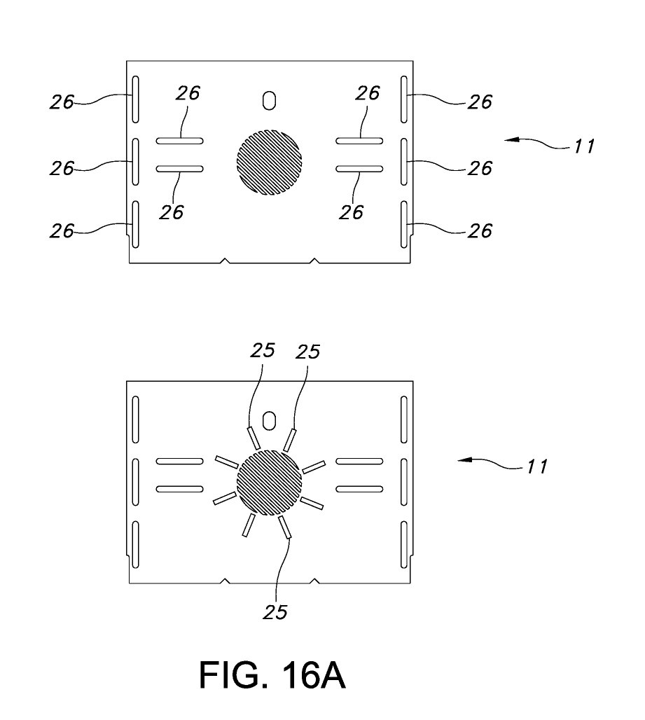

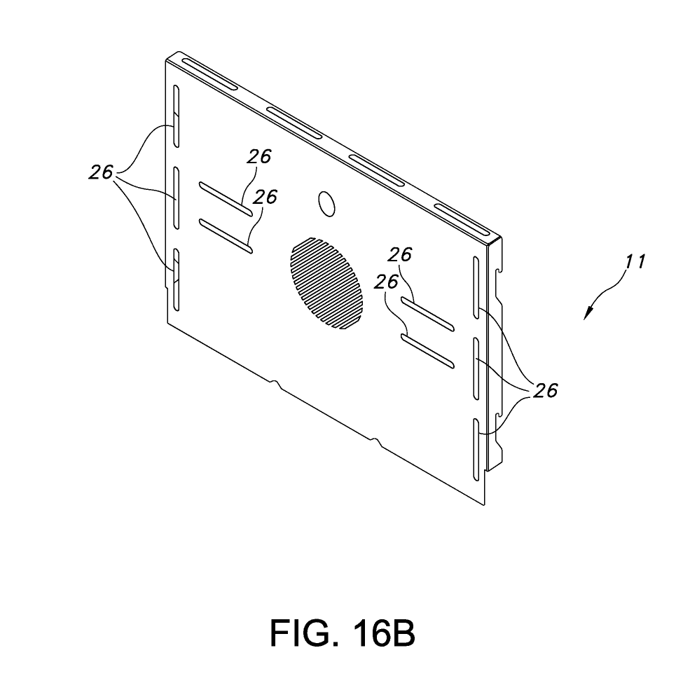

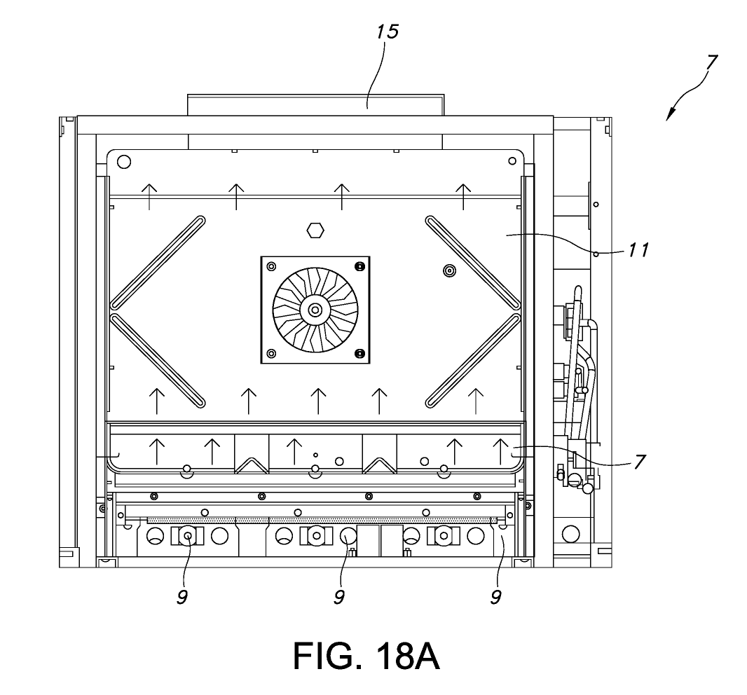

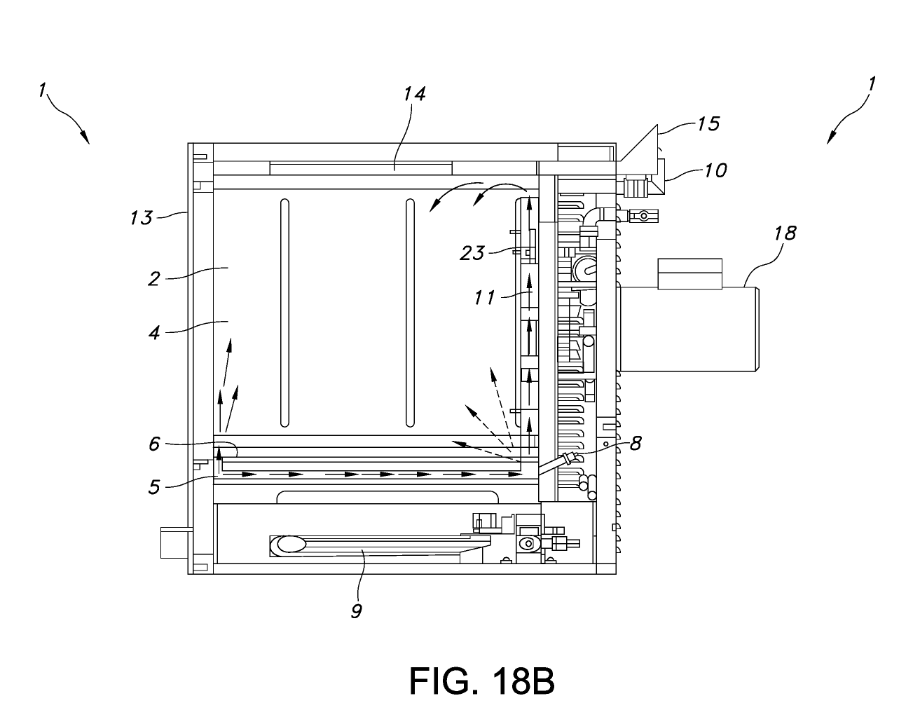

The steam-generating space 5 is divided into two or more reservoirs 7. Optional configurations of the reservoirs 7 are shown in FIG. 13A through FIG. 13D. Each reservoir 7 may be filled with water through its reservoir drain 20, and, in a preferred embodiment, at least one reservoir has a sensor 8 or system of sensors to ensure that the reservoir 7 is adequately filled. Filling the reservoirs 7 through the reservoir drains 20 helps to keep the drains free of clogging by any debris which may be present. The filling or emptying of the reservoirs 7 is controlled by drain valves 21. Heating elements 9, which may be gas burners, electric heating elements, or any other type of heating elements, are disposed beneath the reservoirs 7. An optional configuration for the heating elements 9, when they are gas burners, is shown in FIG. 14. Auxiliary heating elements, not shown, may also be located around the fan 18 in the space between the back baffle 11 and the rear oven cavity wall 3. If the reservoirs 7 contain water, the heating of the heating elements 9 creates steam. At the rear of the cooking cavity 2 but still within the cooking cavity 2 is a back baffle 11. The back baffle 11 is better shown in FIG. 16A and FIG. 16B. As shown by the arrows in FIGS. 18A and 18B, when the oven 1 is in a steam-generating mode, steam generated in the reservoirs 7 travels from the steam generating space 5 into the cooking space 4 through steam lid slots 24, and through a path behind the back baffle 11 entering the cooking space 4 at the upper rear of the cooking cavity 2. Although not shown on the figures, steam also enters the cooking space 4 through the slots 26 in the back baffle 11 which are evident in FIG. 16A and FIG. 16B. In a preferred embodiment of the invention, the steam lid 6 is not flush with the sides of the cooking cavity wall 3, thus steam may also enter the cooking space 4 around the sides of the steam lid 6. In a preferred embodiment, flanges 25 on the back baffle 11 provide for better flow of the steam. In an alternate configuration, the steam is also allowed to enter the cooking space 4 via annular space between the steam lid 6 and the oven cavity wall 3 and/or between the steam lid 6 and the back baffle 11. Hot air follows the same path as the steam in entering the coking space 4. A fan 18 provides both to draw the steam and hot air into the cooking space 4 in steam-generating modes and to provide air flow for dispersion of heat and uniformity of cooking within the oven 1. If the reservoirs 7 are empty, the heat from the heating elements 9 heats the cooking cavity 2 as would a normal oven. In a preferred embodiment, there can be heat dispersion plates 16 between the reservoirs 7 and the heating elements 9 such that the heat more evenly disperses to heat both the water in the reservoirs 7 if present and the cooking cavity 2. When the reservoirs 7 are emptied through the reservoir drains 20, the emptied water then exits the oven 1 through the oven drain 12. In a preferred embodiment of the invention, the steam lid 6 is supported by the raised parts in between the reservoirs 7, by support pins welded on the sides or front wall of the oven cavity walls 3, and by the steam lid drain 19. There is a small gap of approximately 0.5″ to 1″ between the downward flanges of the steam lid 6 and the front and side walls of the oven cavity wall 3. As shown in the steam flow diagram of FIG. 18C, in a preferred embodiment, there may be a small gap between the top of the steam lid 6 and the back baffle 11 such that some of the steam and hot air may enter the cooking space 4 at that joint along the width of the oven.

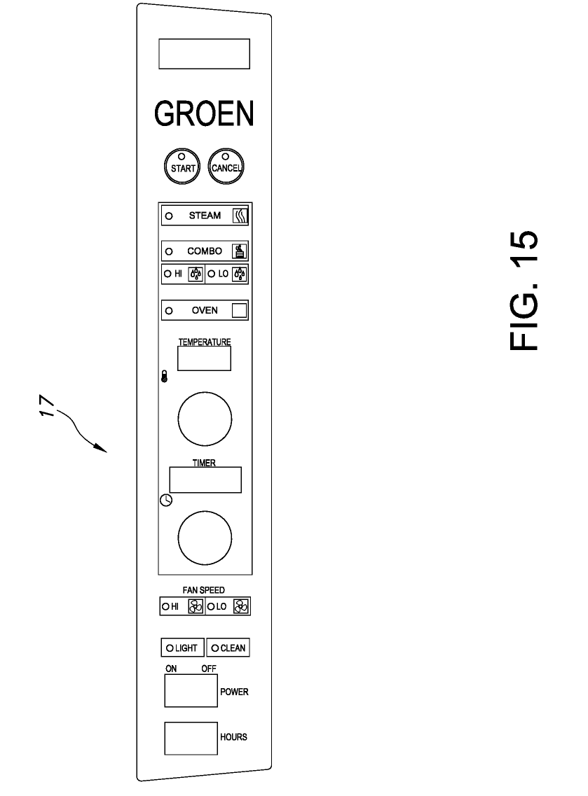

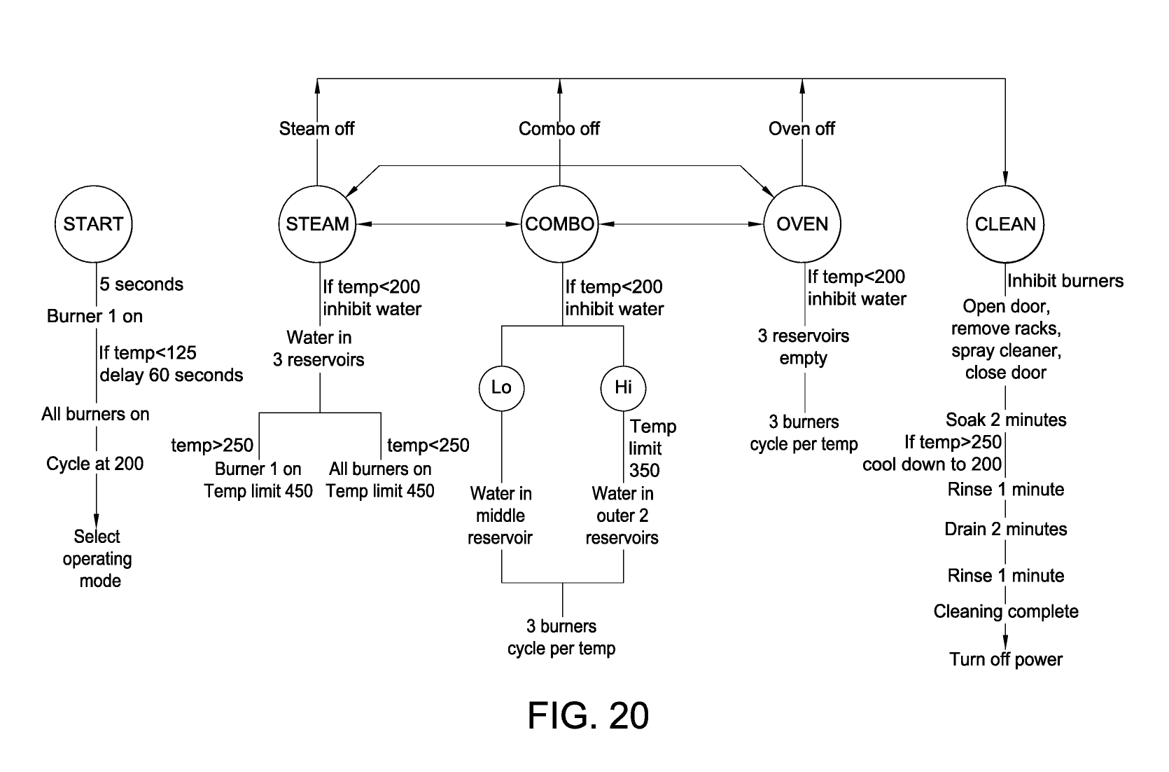

In a preferred embodiment of the invention, the front of the boilerless combination convection steamer oven 1 has a door 13 which may be a single door as shown or which may be double doors or any other door configuration. The front of the boilerless combination convection steamer oven 1 also has controls 17 for the user to select the cooking mode, temperature, fan speed, and other settings. The controls 17 are shown more clearly in FIG. 15. One preferred logic for the controls 17 is described more below and is depicted in FIG. 20, although alternate similar logics can also be effective. The door 13 and controls 17 need not be on the front of the boilerless combination convection steamer oven 1 but could be on any other surface instead.

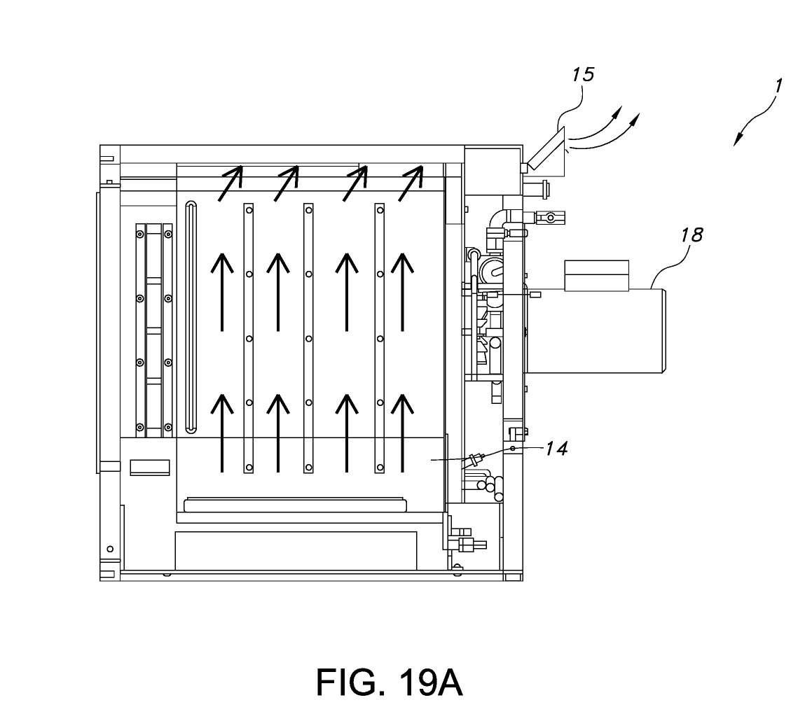

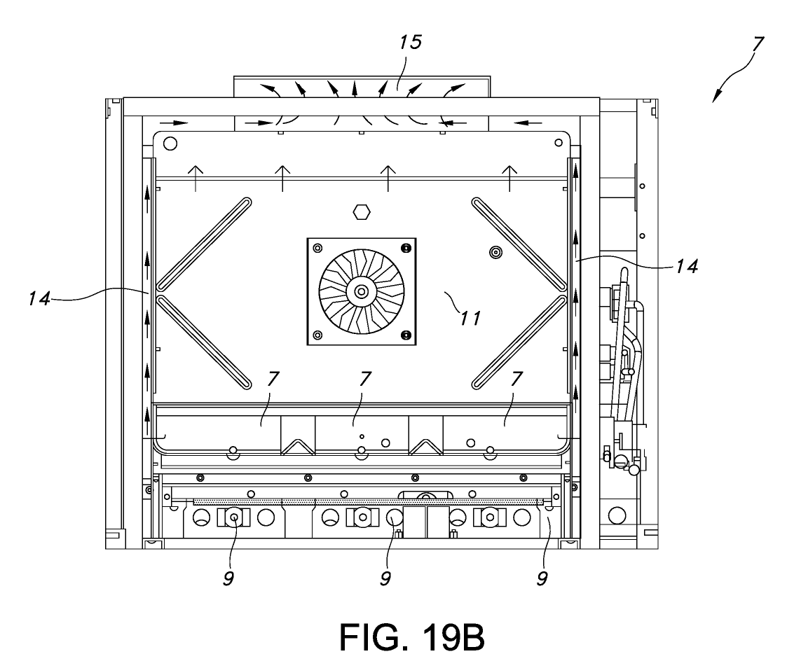

In a preferred embodiment, outside of the cooking cavity 2 but inside of the boilerless combination convection steamer oven 1 is a vent space 14 leading to the exhaust vent 15. As shown in the diagrams on FIG. 19A and FIG. 19B, heating byproducts of the unit, indicated by arrows on those figures, including heated air and any hot flue gasses if a gas burner is used, travel through the vent space 14 around the cooking cavity 2 and then through the exhaust vent 15. A separate oven vent 10 connects the interior of the cooking cavity 2 to the outside such that pressure created by the steam and heated air does not cause the cooking cavity 2 to explode or implode or the cooking cavity wall 3 to buckle.

In a preferred embodiment, a water spray head 23 is provided which allows for the spraying of water into the cooking cavity 2 for cleaning purposes.

Now referring to FIG. 20, the controls logic for the oven 1 and operation in a preferred embodiment of its various modes is depicted. This controls logic is based upon an oven 1 with three reservoirs 7, but it could be modified to work with more or fewer reservoirs, although at least three reservoirs are required to have all of the options disclosed in this controls logic. As displayed in FIG. 20, a user turns on the oven 1 and selects an operating mode. Although it is shown that the user selects the operating mode after the oven has warmed up, the user may select the operating mode at any time. Once started, one heating element 9 turns on. If the temperature inside the oven is below 125 degrees Fahrenheit, there is a sixty second delay before more heating elements 9 turn on. Next, all heating elements 9 turn on until the cooking cavity 2 is warmed to 200 degrees Fahrenheit, as determined by an internal temperature sensor, not shown. In an alternate logic, the heating elements 9 could warm the oven for a predetermined time instead of to a predetermined temperature. The controls logic then controls the heating elements 9 and filling of reservoirs with water as per the selected mode.

In the displayed controls logic, there are modes for STEAM, which is a steamer cooking mode, COMBO Lo and COMBO Hi which are high and low humidity combination heat and steam cooking modes, OVEN, which is a dry heat cooking mode, and CLEAN which is a cleaning mode. If the STEAM mode is selected, all three reservoirs 7 are filled with water once the temperature reaches 200 degrees Fahrenheit. All heating elements 9 turn on when the temperature is below 250 degrees Fahrenheit, and the outer two (2) heating elements 9 turn off if the temperature rises above 250 degrees Fahrenheit. The center heating element 9 is on continuously. This heating element 9 will also shut off if the oven temperature rises above 450 degrees Fahrenheit as may happen if the water supply is shut off and the oven is dry. If the COMBO Lo mode is selected, only the middle reservoir 7 of the three is filled if the temperature is above 200 degrees Fahrenheit, then the heating elements 9 are cycled to maintain the user-selected cooking temperature. If the COMBO Hi mode is selected, the two outer reservoirs 7 of the three are filled if the temperature is above 200 degrees Fahrenheit, then the heating elements 9 are cycled to maintain the user-selected cooking temperature. If the OVEN mode is selected, no reservoirs 7 are filled, and the heating elements 9 are cycled to maintain the user-selected cooking temperature. If the CLEAN mode is selected, the heating elements 9 are first inhibited and a user sprays the interior of the oven 1 with a spray cleaner and closes the oven door. The controls logic allows for the oven 1 to soak for two minutes. Next, if the temperature is above 250 degrees Fahrenheit the oven 1 is allowed to cool down to about 200 degrees Fahrenheit. Once the temperature is below 200 degrees Fahrenheit, the water spray head 23 rinses the interior of the cooking cavity wall 3 for one minute. The oven 1 drains for two minutes and then repeats the rinse for one minute before shutting off.

Although the foregoing invention has been described in some detail by way of illustration and example for purposes of clarity of understanding, it will be obvious that certain changes and modifications may be practiced within the scope of the appended claims.

We claim:

1. A boilerless combination convection steamer oven comprising:
(a) a cooking cavity formed by a cooking cavity wall comprising a cooking space separated from a steam generating space by a removable steam lid, wherein the steam generating space comprises a plurality of at least two reservoirs for use in generating steam when a steam-generating mode is chosen;
(b) a plurality of at least two heating elements; and
(c) controls which a user may use to select cooking modes, wherein there are a plurality of at least two available cooking modes selected from the list of a dry heat cooking mode, a steamer only cooking mode, and a combination steam and heat cooking mode.

2. The boilerless combination convection steamer oven of claim 1 wherein the plurality of at least two heating elements are situated under the plurality of at least two reservoirs such that they provide heat both to heat the water in the reservoirs to create steam in a steam-generating mode and to the cooking cavity to heat the cooking cavity.

3. The boilerless combination convection steamer oven of claim 1 wherein the plurality of at least two heating elements are individually controlled, such that each one may be switched on and off separately.

4. The boilerless combination convection steamer oven of claim 1 further comprising a vent space around the cooking cavity wall wherein the plurality of at least two heating elements produce heating byproducts which are vented through said vent space, said heating byproducts providing further heating to the cooking cavity.

5. The boilerless combination convection steamer oven of claim 1 wherein the number of reservoirs filled is determined according to the controls such that no reservoirs are filled for dry heat cooking mode, all reservoirs are filled in steamer only cooking, and some, but less than all, reservoirs are filled for combination steam and heat cooking mode.

6. The boilerless combination convection steamer oven of claim 1 comprising at least three reservoirs and more than one combination steam and heat cooking mode, wherein there is a low-humidity combination steam and heat cooking mode where at least one reservoir is filled, and a high-humidity combination steam and heat cooking mode where more than one but less than the total number of reservoirs are filled.

7. A controls logic for the boilerless combination convection steamer oven of claim 1 comprising the steps of:
(a) the boilerless combination convection steamer oven is first warmed to a predetermined temperature;
(b) a number between zero and all of the reservoirs are filled with water according to the cooking mode chosen by the user; and
(c) the heating elements are individually controlled to maintain a preset temperature.

8. The controls logic of claim 7 further comprising a cleaning mode option.

9. A controls logic for the boilerless combination convection steamer oven of claim 1 comprising the steps of:
(a) the boilerless combination convection steamer oven is first warmed for a predetermined time;
(b) a number between zero and all of the reservoirs are filled with water according to the cooking mode chosen by the user; and
(c) the heating elements are individually controlled to maintain a preset temperature.

10. The controls logic of claim 9 further comprising a cleaning mode option.
